(19) United States
(12) Patent Application Publication
(10) Pub. No.: US 2007/0279905 A1
(43) Pub. Date: Dec. 6, 2007

(54) Illuminable Container

(76) Inventor: Boyi Chan, Taipei (TW)

Correspondence Address: WPAT, PC;INTELLECTUAL PROPERTY ATTORNEYS, 2030 MAIN STREET, SUITE 1300, IRVINE, CA, 92614, US

(21) Appl. No.: 11/421,738

(22) Filed: Jun. 1, 2006

(51) Int. Cl. F21V 33/00

(52) U.S. Cl. 362/253

(57) ABSTRACT

An illuminable container is disclosed herein, which is a hollow cup body with a single-walled or a double-walled structure made of translucent material. A bottom thereof is illuminated by a light source having controllable flash patterns to obtain better and variegated visual and aesthetic effects. The illuminable container comprises a container body, a base, a light source, and an AC/DC power supply. The light emitted by the light source powered by the base illuminates the container body to produce translucent visual effect.

### BACKGROUND OF THE INVENTION

1. Field of the Invention

The present invention relates to an illuminable container, and in particular to a hollow cup body made of translucent material and having a single-walled or double-walled structure. A bottom thereof is illuminated by a light source with controllable flash patterns for obtaining better and variegated visual and aesthetic effect.

2. The Prior Arts

A conventional illuminable container has a single-walled structure, which results in dull reflection and refraction of light and lack of variation in visual effect. In addition, the conventional illuminable container is energized with Direct Current power supply solely; therefore, it is limited in the duration of power and the selection of power supply types.

### SUMMARY OF THE INVENTION

A primary object of the present invention is to provide an illuminable container that can enhance and variegate the visual effect thereof by directing light emitted by a light source through the container body made of translucent material.

In compliance with the aforementioned object, an illuminable container in accordance with the present invention comprises a container body and a base. The container body is a hollow cup body having a double-walled structure. An inner side wall defines a storage space opening upward. Enclosed between the inner side wall and an outer side wall is a peripheral space, which extends to a bottom of the container body.

The base is connected with a bottom portion of the peripheral space of the container body. The base comprises a plate body, a circuit board, at least one light source disposed along a perimeter of the circuit board, a power switch, a control switch, an AC power jack, and a battery cover. The power switch and control switch are disposed at a peripheral surface of the plate body and are inserted through a button through hole formed at a bottom side wall of the container to be connected with a button, respectively. A battery chamber is disposed at the plate body, which is closed by a battery cover. The circuit board is mounted on a surface of the plate body, with at least one light source disposed along a perimeter thereof. The light emitted by the light source is directed from the peripheral space and the container storage space through the outer side wall outwardly. The AC power jack is disposed at the peripheral surface of the plate body corresponding to an AC power insertion hole formed at the bottom side wall of the container for engaging with an AC power supply. The power switch controls the on/off state of the light source. On the other hand, the control switch controls the flash pattern of the light source.

### BRIEF DESCRIPTION OF THE DRAWINGS

The present invention will be apparent to those skilled in the art by reading the following detailed description of preferred embodiments thereof, with reference to the attached drawings, in which:

FIG. 1 is an exploded perspective view of an illuminable container according to the present invention;

FIG. 2 is a reverse exploded perspective view of FIG. 1;

FIG. 3 is an assembled view of FIG. 1;

FIG. 4 is a cross-sectional view of an illuminable container having a peripheral space according to the present invention; and

FIG. 5 is a cross-sectional view of an illuminable container without a peripheral space according to another preferred embodiment of the present invention.

### DETAILED DESCRIPTION OF THE PREFERRED EMBODIMENT

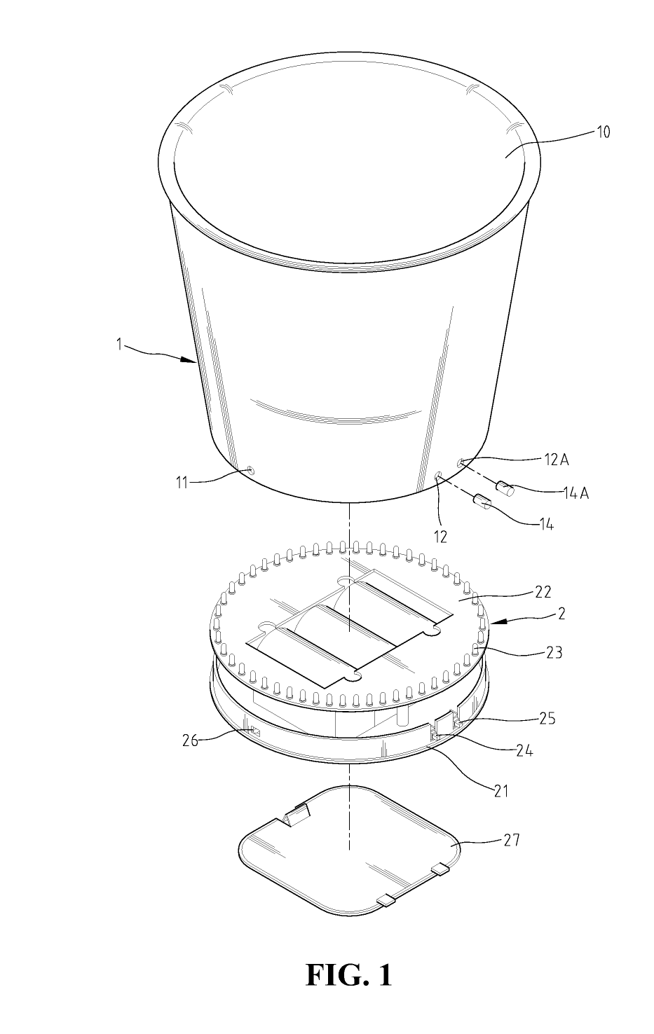

With reference to FIG. 1, an illuminable container in accordance with the present invention comprises a container body 1 and a base 2. The container body 1 is a hollow cup body with a double-walled structure made of translucent material, such as acrylic, and plastic. The hollow cup body has a storage space 10 opening upward. In application, the container body 1 may serve as an ice pail, a flowerpot, or a wastebasket.

The base 2 that is connected with a bottom of the container body 1 includes a plate body 21, a circuit board 22, at least one light source 23 disposed along a perimeter of the circuit board 22, a power switch 24, a control switch 25, an AC power jack 26, and a battery cover 27.

The power switch 24 and the control switch 25 are disposed at a peripheral surface of the plate body 21, which are inserted through two button through holes 12 and 12A formed at a bottom side wall of the container body 1, and are connected with buttons 14, and 14A, respectively. The bottom of the plate body 21 is covered with the battery cover 27. The circuit board 22 is mounted on the plate body 21, with the at least one light source 23 disposed along the perimeter of the circuit board 22.

The AC power jack 26 is disposed at the peripheral surface of the plate body 21 at a position corresponding to an AC power insertion hole 11 formed at the bottom side wall of the container body 1 for connection with the AC power supply. The power switch 24 controls the on/off state of the light source 23, while the control switch 25 controls the flash pattern of the light source 23.

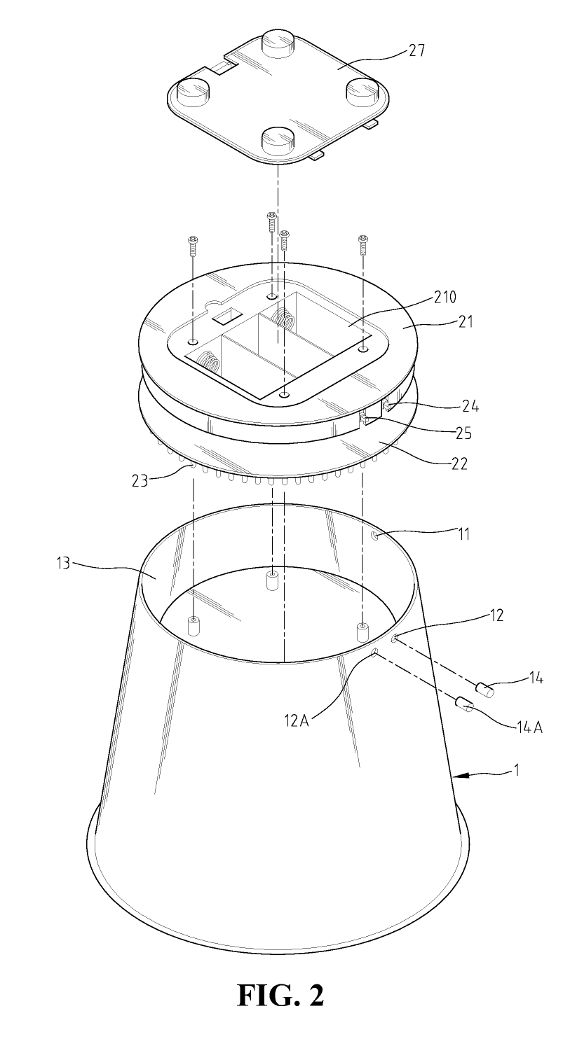

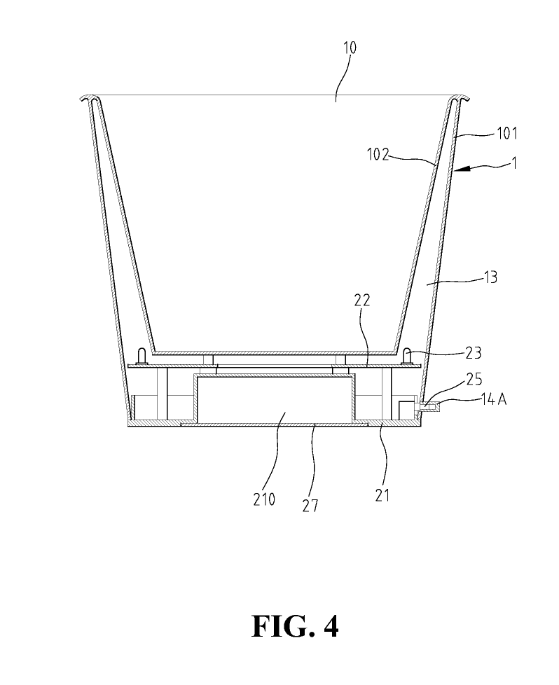

With reference to FIG. 2, a peripheral space (see FIG. 4) is extended downwards to form a bottom space of the container body 1. The base 2 is received and fixed in the bottom space of the container body 1. The plate body 21 has a battery chamber for holding batteries, alkaline batteries, or rechargeable batteries. A bottom of the plate body 21 is covered with the battery cover 27.

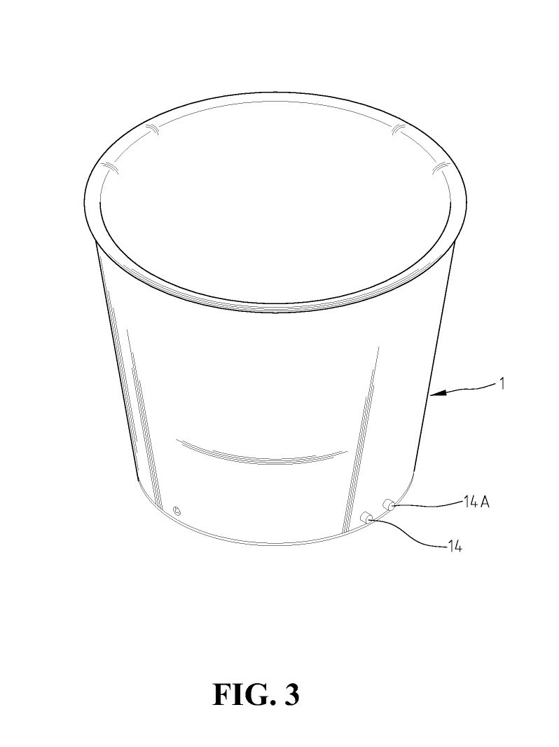

With reference to FIG. 3, which shows an appearance of the illuminable container according to the present invention, the container body 1 is a hollow cup body having a double-walled structure, which is made of translucent material and opens upward. The button 14 for controlling power supply and the button 14A for controlling flash patterns are disposed at the bottom thereof.

Referring to FIG. 4, which illustrates an illuminable container having a peripheral space according to a preferred embodiment of the present invention, the container body 1 is a hollow cup body with a double-walled structure and made of translucent materials. An inner side wall 102 defines a storage space 10 which opens upward. Enclosed between the inner side wall 102 and an outer side wall 101 is a peripheral space 13, which extends to the bottom of the container body 1.

The bottom space of the container body 1 receives a plate body 21 and a circuit board 22. The plate body 21 has a battery chamber 210 for holding batteries, alkaline batteries, or rechargeable batteries. The battery cover 27 closes a downward opening of the battery chamber 210. At least one light source 23 is disposed at the perimeter of the circuit board 22. However, in application, the light sources 23 may be disposed spacing apart from each other along the perimeter of the circuit board 22.

Light emitting components, such as light emitting diodes (LED) and light bulbs may be employed as the light source 23. The light emitted by the light source 23 travels from the peripheral space 13 and a bottom of the storage space 10, through the inner side wall 102 of the container body 1, into the storage space 10, on the one hand, and travels from the peripheral space 13 through the outer wall 101 of the container body 1 outwardly. The multi-directional transmission of the light emitted by the light source 23 provides the translucent container body 1 with better and variegated visual effect.

The control switch 25 disposed at the peripheral surface of the plate body 21 is connected to a button 14A for controlling the flash pattern of the light source 23, so that the variation of flash pattern may be achieved by merely utilizing a limited number of light sources 23.

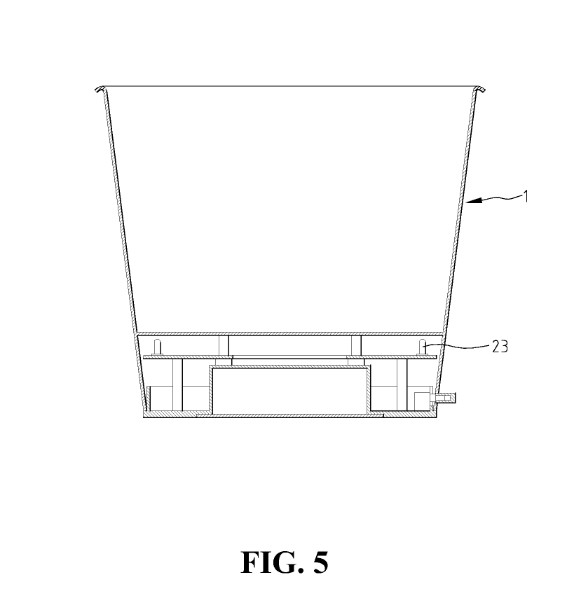

FIG. 5 illustrated another embodiment of the present invention, which has an identical structure to the embodiment in FIG. 4, except that it is structured with a single wall. The light emitted by the light source 23 travels through a bottom of the container body 1 to illuminate the upper half of the container body 1, which provides the container with better and variegated visual effect.

In sum, the improvement for better and variegated visual effect of an illuminable container intended by the present invention is achieved by illuminating the translucent container with light emitted by a light source located within the bottom thereof. Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. An illuminable container, comprising:
a container body which is a hollow cup body with a double-walled structure made of translucent material, having a storage space which is defined by an inner side wall and opens upward, as well as a peripheral space enclosed by the inner side wall and an outer side wall and extending to a bottom thereof;
a base connected with a bottom space of the container body, including:
a plate body;
a circuit board mounted on the plate body;
at least one light source disposed at a perimeter of the circuit board, the light emitted by the light source traveling through the peripheral space to the storage space and outside the container;
a power switch and a control switch which are disposed at a peripheral surface of the plate body and are inserted through a button through hole formed at a bottom side wall of the container to be connected to a button, respectively; and
a battery cover, which closes a battery chamber disposed in the plate body.

2. The illuminable container as claimed in claim 1, wherein the plate body has an AC power jack at a peripheral surface thereof, which corresponds to an AC power insertion hole formed at the bottom side wall of the container body for connection with an AC power supply, which, with the power switch, controls the on/off state of the light source.

3. The illuminable container as claimed in claim 1, wherein the control switch controls the flash pattern of the light source.
